(19) United States
(12) Patent Application Publication
(10) Pub. No.: US 2013/0086013 A1
(43) Pub. Date: Apr. 4, 2013

(54) SYSTEM AND METHOD OF SAVING FILES TO A VERSION CONTROL SYSTEM ("VCS") REPOSITORY

(71) Applicants: Blaine Madison Mucklow, Smyrna, GA (US); Vaughn Bernard McMullin, Snellville, GA (US); Ramon Juan San Andres, Duluth, GA (US)

(72) Inventors: Blaine Madison Mucklow, Smyrna, GA (US); Vaughn Bernard McMullin, Snellville, GA (US); Ramon Juan San Andres, Duluth, GA (US)

(73) Assignee: GENERAL ELECTRIC COMPANY, Schenectady, NY (US)

(21) Appl. No.: 13/248,467

(22) Filed: Sep. 29, 2011

(51) Int. Cl. G06F 17/30

(52) U.S. Cl. 707/695; 707/E17.005

(57) ABSTRACT

A method of saving files to a version control system (“VCS”) repository located on a VCS server is provided. The VCS repository has at least two files. The method includes executing at least two processes by at least one server. The method includes creating a workspace for each of the at least two processes. The workspace corresponds to one of the at least two processes. The method includes saving a temporary version of at least one target file selected from the VCS repository to the workspace. Each of the at least two processes has the temporary version of the at least one target file saved to the workspace. The method includes committing the temporary version of the at least one target file back to the VCS repository.

### BACKGROUND OF THE INVENTION

The subject matter disclosed herein relates to a system and method of providing a version control system (“VCS”) repository, and particularly to a system and method of saving files to a VCS repository.

One challenge faced in large scale software development is the issue of concurrency with multiple threads. For various types of processing applications, a system may handle multiple events or processes concurrently. Specifically, a process may have multiple threads. A thread is a basic unit of program execution. At any given time, a program may have multiple threads running concurrently, where each thread performs a different job.

Concurrency issues may occur when multiple processes or threads are used. For example, one issue that may occur is deadlocking. One example of a deadlock is when a thread, which is referred to as t1, owns resource A and wants to acquire resource B, which is owned by thread t2. For thread t1 to access resource B, thread t1 has to wait until thread t2 releases resource B. However, in the event thread t2 is waiting for thread t1 to release resource A before releasing resource B, t2 remains in a wait state. This creates a situation where threads t1 and t2 are unable to proceed. Also, sometimes a particular thread may wait on the resources that the same thread already currently owns, which leads to an infinite wait condition.

In one approach, concurrency issues may be reduced by locking files such that only one software developer at a time may have write access to a centrally located file located in a repository. Thus, once a software developer checks out a specific file, other developers may read the specific file, but no other software developer may modify the specific file until the specific file is checked back into the repository. However, this approach may not be efficient, as only one software developer at a time is able to modify a specific file.

### BRIEF DESCRIPTION OF THE INVENTION

According to one aspect of the invention, a method of saving files to a version control system (“VCS”) repository located on a VCS server is provided. The VCS repository has at least two files. The method includes executing at least two processes by at least one server. The method includes creating a workspace for each of the at least two processes. The workspace corresponds to one of the at least two processes. The method includes saving a temporary version of at least one target file selected from the VCS repository to the workspace. Each of the at least two processes has the temporary version of the at least one target file saved to the workspace. The method includes committing the temporary version of the at least one target file back to the VCS repository.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is an illustration of an exemplary version control system (“VCS”);

FIG. 2 is an illustration of an alternative embodiment of the VCS shown in FIG. 1;

FIG. 3 is a process flow diagram illustrating an exemplary process of operating the VCS shown in FIGS. 1-2.

The detailed description explains embodiments of the invention, together with advantages and features, by way of example with reference to the drawings.

### DETAILED DESCRIPTION OF THE INVENTION

As used herein the terms module and sub-module refer to an application specific integrated circuit (ASIC), an electronic circuit, a processor (shared, dedicated, or group) and memory that executes one or more software or firmware programs, a combinational logic circuit, and/or other suitable components that provide the described functionality.

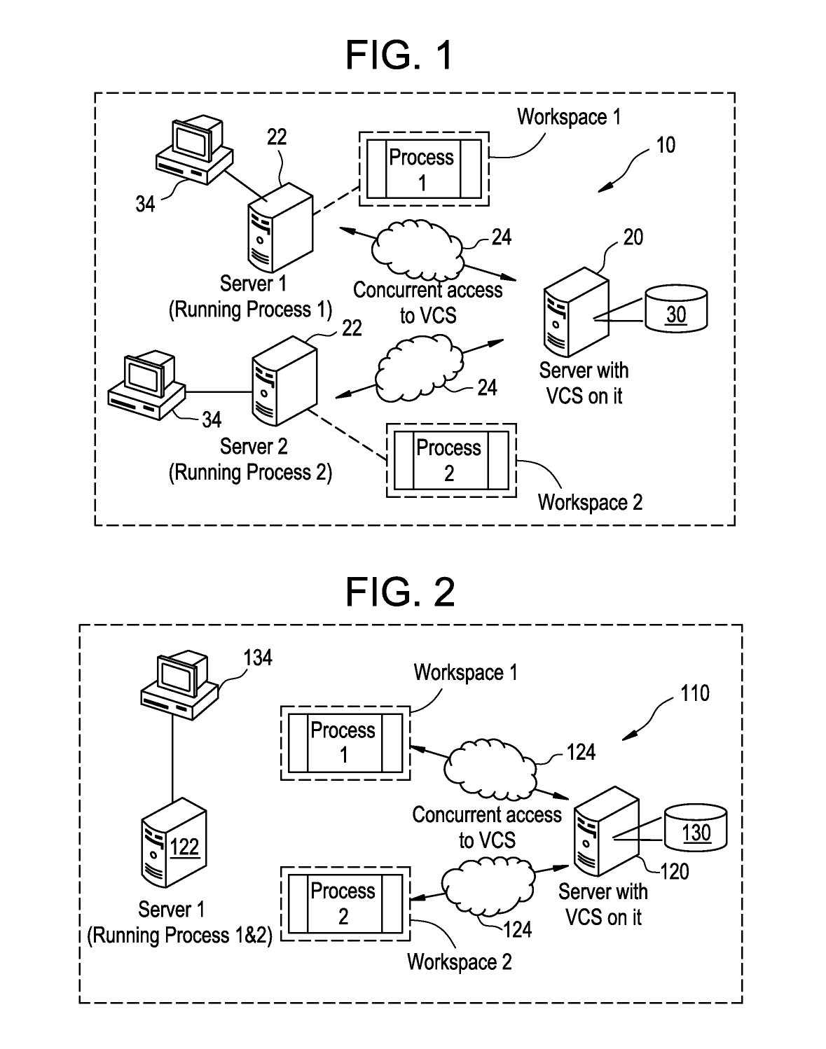

Referring now to FIG. 1, an embodiment of an exemplary version control system (“VCS”) 10 is illustrated. The VCS 10 is any type of application for managing changes to documents and programs stored as computer files. The file revision system 10 includes a VCS server 20 that is in communication with a plurality of servers 22. The VCS server 20 may be in communication with each of the servers 22 though a network connection 24, where the network connection 24 is any type of computer network such as, for example, a local area network (“LAN”) or a wide area network (“WAN”). The VCS server 20 executes a VCS program, and includes a memory that stores a VCS repository 30. The VCS repository 30 stores a plurality of files. Specifically, in one embodiment, the VCS repository 30 saves a single complete version of a dataset, as well as deltas that store the changes from one version of the dataset to another. In one embodiment, the VCS repository may be a concurrent version system (“CVS”) repository, a subversion (“SVN”) repository, or a Git repository.

The VCS 10 is configured for executing at least two processes. In the exemplary embodiment as shown in FIG. 1, the plurality of servers 22 are illustrated as server 1 and server 2. Both the servers 22 include control logic for executing at least one process. Specifically, the example as shown in FIG. 1 illustrates server 1 executing process 1, and server 2 executing process 2. That is, in the embodiment of FIG. 1, each process is executed by a different server 22. However, it is to be understood that in another embodiment, a plurality of processes are executed on the same server 22. It is also noted that while FIG. 1 illustrates process 1 and process 2, more than two processes may also be executed on the servers 22 as well. For example, FIG. 2 is an alternative embodiment of a VCS 110 and illustrates a VCS server 120 is in communication with a single server 122. In the embodiment as shown in FIG. 2, both process 1 and process 2 are executed by the same server 122.

It should be noted that while FIGS. 1-2 describe the servers 22 and 122 as executing multiple processes, it is to be understood that the servers 22 and 122 may also execute threads as well. Specifically, process 1 may be thread 1, and process 2 may be thread 2. A thread is typically a single, sequential flow of control within a computing device. A process may have multiple concurrently executing threads. The servers 22 and 122 are capable of executing instructions written in a programming language that supports multiple threads, and process 1 and process 2 are written in a programming language that supports multiple threads. For example, in one embodiment, the Java ® programming language may be used.

Continuing to refer to FIGS. 1-2, each of the servers 22 and 122 may be in communication with at least one thin client, where servers 22 are each in communication with a thin client 34, and the server 122 is in communication with a thin client 134. The thin clients 34 and 134 may be a computer terminal that provides a graphical user interface (“GUI”) to an end-user.

As processes 1 and 2 execute, process 1 and process 2 may require at least one of the plurality of files that are stored on the VCS repository 30. Thus, process 1 and process 2 may be communicated over the network 24 to the VCS server 20. The VCS server 20 includes control logic for determining the appropriate file in the VCS repository 30, depending on the resources required by the specific process. Specifically, the VCS server 20 includes control logic for determining a target file or files required by process 1, and the VCS server 20 also includes control logic for determining the a target file or files that are required by process 2. In one embodiment, the target file or files from the VCS repository 30 may be the same for process 1 and process 2, however it is to be understood that process 1 may require different target files from process 2 as well. In one illustrative embodiment where Java ® is used, process 1 and process 2 both pass through a File Directive object. The File Directive object specifies the particular file in the VCS repository 30 that is required by either process 1 or process 2.

Once the VCS server 20 selects the target file or files from the VCS repository 30, a workspace is created. Specifically, referring now to FIG. 1, folder 1 is created to store workspace 1 on server 1 for process 1. Folder 2 is also created to store workspace 2 on server 2 for process 2. Thus, a unique workspace is created for each process. In the embodiment as shown in FIG. 2, two workspaces are created on the server 122, where folder 1 is created to store workspace 1 for process 1, and folder 2 is created to store workspace 2 for process 2. That is, multiple folders for storing multiple workspaces may be created on the same server 122. The workspace is used to store a temporary version of one of the target file or files from the VCS repository 30. A workspace represents a client-side copy of the target file from the VCS repository 30. The workspace serves as an isolated area where modifications to the temporary version of the target file may be performed by an end-user. Thus, because both process 1 and process 2 have a unique workspace that stores the target file, process 1 and process 2 are able to read and write to the same target file without creating concurrency issues.

Once an end-user is finished making revisions to the temporary version of the target file saved in the workspace, the temporary version of the target file may be committed back to the VCS repository 30. The commit operation, which is also referred to as a check-in operation, involves saving the revisions made to the temporary version of the target file back to the VCS repository 30 as a revision file. The commit operation will make any changes made to the temporary version of the target file final and available to all end-users. Specifically, server 1 and server 2 may each send a commit signal over the network 24, which causes the VCS server 20 to pick up the temporary version of the target file from workspace 1 and workspace 2. Once the temporary version of the target file from is committed to the VCS repository 30 as the revision file, the VCS server 20 includes control logic for sending a signal back to the respective process being executed on the server 22 indicating the revision number and the location of where the revision file is saved in the VCS repository 30. For example, once an end-user is finished making revisions to the temporary version of the target file saved in workspace 1, the temporary version of the file is committed back to the VCS repository 30 with a specific revision number. In one illustrative embodiment, the temporary version of the file is saved in the VCS repository 30 as a revision file named “Revision 1.0”. A signal is sent over the network 24 back to process 1 located on server 1 that indicates the revision number (i.e., in the example as described the revision number would be 1.0) and the location of the revision file.

Once the temporary version of the target file has been committed back to the VCS repository 30, the temporary file may be deleted from the respective workspace. For example, if Java® is employed, a dispose method may be used to dispose of the respective workspace. In one illustrative embodiment, once the revision file “Revision 1.1” is saved to the VCS repository 30, then a dispose method is employed to dispose of workspace 1.

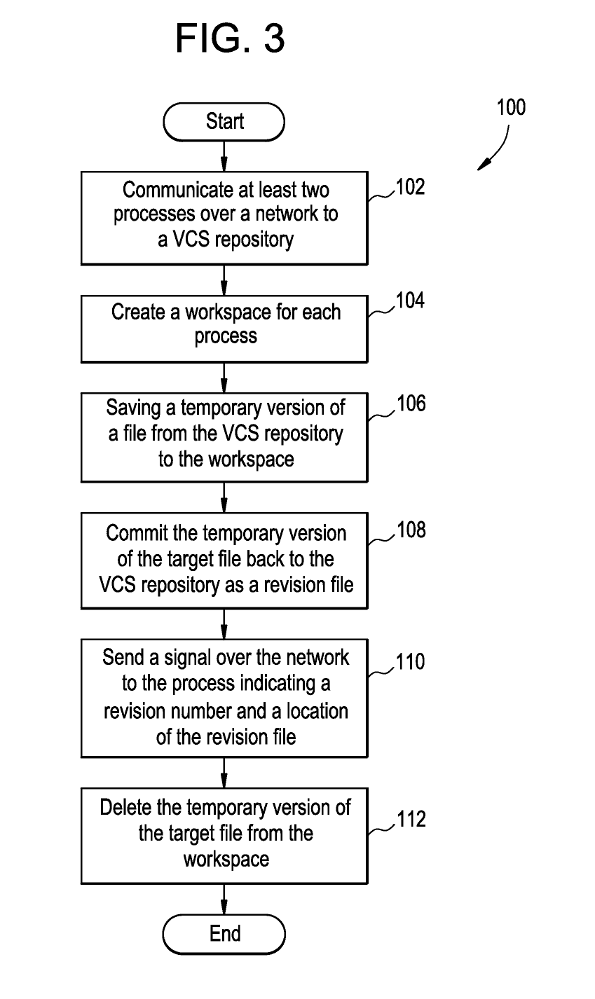

A method of using the VCS 10 for saving files to the VCS repository 30 will now be discussed. FIG. 3 is a process flow diagram illustrating a method 100 of saving files to the VCS repository 30. Referring now to FIGS. 1 and 3, method 100 begins at 102, where at least two processes that are executed on a server 22 are communicated over a network 24 to a VCS server 20. The VCS server 20 includes control logic for determining the appropriate file in the VCS repository 30, depending on the resources required by the specific process. In the embodiment as shown in FIGS. 1-2, the processes are process 1 and process 2. The VCS server 20 includes control logic for determining a target file or files required by process 1, and the VCS server 20 also includes control logic for determining the a target file or files that are required by process 2. In one embodiment, the target file or files from the VCS repository 30 may be the same for process 1 and process 2, however it is to be understood that process 1 may require different target files from process 2 as well. Method 100 may then proceed to 104.

In 104, a workspace is created for each process. Thus, each process is allocated one of the workspaces. For example, referring to FIG. 1, a workspace 1 is created on server 1 for process 1, and a workspace 2 is created on server 2 for process 2. In an alternative embodiment as shown in FIG. 2, two workspaces are created on a server 122, where a workspace 1 is created for process 1, and a workspace 2 is created for process 2. Method 100 may then proceed to 106.

In 106, a temporary version of a target file or files from the VCS repository 30 is saved on each workspace. Method 100 may then proceed to 108.

In 108, the temporary version of the target file is committed back to the VCS repository 30 as a revision file. For example, referring to FIG. 1, once an end-user is finished making revisions to the temporary version of the target file saved in workspace 1, the temporary version of the file is committed back to the VCS repository 30 with a specific revision number. In one illustrative embodiment, the temporary version of the file is saved in the VCS repository 30 as a revision file named “Revision 1.0”. Method 100 may then proceed to 110.

In 110, a signal is sent over the network 24 back to the process indicating the revision number of the revision file and the location of the revision file. For example, referring to FIG. 1, a signal may be sent to process 1 located on server 1 indicating the revision number (i.e., in the example as described in step 108 the revision number would be 1.0) and the location of the revision file. Method 100 may then proceed to 112.

In 112, the temporary version of the target file is deleted from the respective workspace. For example, if Java® is employed, a dispose method may be used to dispose of the respective workspace. Method 100 may then terminate.

The VCS 10 as shown in FIGS. 1-2 is configured for providing a unique workspace that stores the target file, and provides an end-user or multiple end-users the ability to read and write to the same file stored in the VCS repository 30 without creating concurrency issues. Moreover, because the VCS system 10 only stores the changes made to a file once the file is committed back to the VCS repository 30, the amount of disk space that is required to store the file revisions is generally less than some other types of data storage approaches. The need for less disk space may be especially useful in the event relatively large files are used to store numerous revisions.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of saving files to a version control system (“VCS”) repository located on a VCS server, the VCS repository having at least two files, comprising:
executing at least two processes by at least one server;
creating a unique workspace for each of the at least two processes, wherein each of the workspaces correspond to one of the at least two processes;
saving a temporary version of at least one target file selected from the VCS repository to each of the workspaces, each of the at least two processes having the temporary version of the at least one target file saved to a corresponding workspace such that each of the at least two processes read and write from the temporary version of the at least one target file without creating concurrency issues; and
committing revisions made to the temporary version of the at least one target file by each of the workspaces back to the VCS repository as separate revision files.

2. The method as recited in claim 1, comprising deleting the temporary version of the at least one target file after committing the temporary version of the at least one target file back to the VCS repository.

3. The method as recited in claim 2, comprising providing a dispose method to delete the temporary version of the at least one target file.

4. The method as recited in claim 1, comprising executing the at least two processes using a programming language that is configured for supporting multiple threads.

5. The method as recited in claim 1, comprising assigning a revision number for each temporary version of the at least one target file that is committed back to the VCS repository on the VCS server.

6. The method as recited in claim 1, wherein the VCS repository is one of a concurrent version system (“CVS”) repository, a subversion (“SVN”) repository, and a Git repository.

7. The method as recited in claim 1, wherein the at least one server is a single server, and wherein the single server is in communication with the VCS server.

8. The method as recited in claim 1, comprising providing at least one thin client that is in communication with the at least one server.

9. The method as recited in claim 1, wherein the at least one server is a plurality of servers, and wherein one of the at least two processes is executed on one of the plurality of servers, and another one of the at least two processes is executed on another one of the plurality of servers, and wherein the plurality of servers are each in communication with the VCS server.

10. The method as recited in claim 1, comprising providing an identical at least one target file for each of the at least two processes.

11. A method of saving files to a version control system (“VCS”) repository located on a VCS server, the VCS repository having at least two files, comprising:
executing at least two processes by at least one server;
creating a unique workspace for each of the at least two processes, wherein each of the workspaces correspond to one of the at least two processes;
saving a temporary version of at least one target file selected from the VCS repository to each of the workspaces, each of the at least two processes having the temporary version of the at least one target file saved to a corresponding workspace such that each of the at least two processes read and write from the temporary version of the at least one target file without creating concurrency issues;
committing revisions made to the temporary version of the at least one target file by each of the workspaces back to the VCS repository as separate revision files;
assigning a revision number for each temporary version of the at least one target file committed back to the VCS repository; and
deleting the temporary version of the at least one target file after committing the temporary version of the at least one target file back to the VCS repository.

12. The method as recited in claim 11, comprising providing a dispose method to delete the temporary version of the at least one target file.

13. The method as recited in claim 11, comprising executing the at least two processes using a programming language that is configured for supporting multiple threads.

14. The method as recited in claim 11, wherein the VCS repository is one of a concurrent version system (“CVS”) repository, a subversion (“SVN”) repository, and a Git repository.

15. The method as recited in claim 11, wherein the at least one server is a single server, and wherein the single server is in communication with the VCS server.

16. The method as recited in claim 11, comprising providing at least one thin client that is in communication with the at least one server.

17. The method as recited in claim 11, wherein the at least one server is a plurality of servers, and wherein one of the at least two processes is executed on one of the plurality of servers, and another one of the at least two processes is executed on another one of the plurality of servers, and wherein the plurality of servers are each in communication with the VCS server.

18. A version control system (“VCS”) for saving files, comprising:
a version control system (“VCS”) server having a memory with a VCS repository stored thereon, the VCS repository having at least two files; and
at least one server in communication with the VCS server, the at least one server executing at least two processes, the at least one server having a unique workspace for each of the at least two processes, wherein each of the workspaces correspond to one of the at least two processes, and a temporary version of at least one target file selected from the VCS repository is saved to the each of the workspaces, and each of the at least two processes having the temporary version of the at least one target file saved to a corresponding workspace such that each of the at least two processes read and write from the temporary version of the at least one target file without creating concurrency issues, and revisions made to the temporary version of the at least one target file by each of the workspaces are committed back to the VCS repository as separate revision files.

19. The VCS as recited in claim 18, wherein the VCS repository includes a revision file, wherein the revision file is the temporary version of the at least one target file that is committed back to the VCS repository.

20. The VCS as recited in claim 18, wherein the VCS repository is one of a concurrent version system (“CVS”) repository, a subversion (“SVN”) repository, and a Git repository.
